(19) United States
(12) Patent Application Publication
(10) Pub. No.: US 2011/0276497 A1
(43) Pub. Date: Nov. 10, 2011

(54) SYSTEM AND METHOD FOR DEBT SETTLEMENT

(76) Inventor: WILLIAM PATTON, Cave Creek, AZ (US)

(21) Appl. No.: 12/773,769

(22) Filed: May 4, 2010

(51) Int. Cl. G06Q 40/00; G06Q 10/00

(52) U.S. Cl. 705/80; 705/35

(57) ABSTRACT

A system and method for debt settlement has a user enter debt information for each creditor of the user. A first letter is generated to each creditor of inability of user to maintain current credit terms. The first letter is sent to each creditor.

### FIELD OF THE INVENTION

The present invention relates to debt settlement programs, and more specifically, to a method of internet debt settlement for the specific purpose of providing individuals with an internet based debt settlement module and or program that allow the individual to negotiate directly with their creditors without the use of a debt settlement company and or attorney.

### BACKGROUND OF THE INVENTION

It can be appreciated that debt settlement programs have been in use for years. Typically, debt settlement programs vary in their approach to obtaining the goal of reducing the total amount of debt that a consumer owes. These methods include debt reduction, a process of reducing the interest and fees due the creditor and allow the consumer to pay the current amount owed to the creditor. Another method is debt settlement, a process that allows the consumer to settle their current balance due a creditor for a lesser amount.

The main problem with conventional debt settlement programs is the fees associated with “retaining” a traditional debt settlement or consumer credit counseling company or an attorney to negotiate on the consumers behalf. Another problem with conventional debt settlement programs is they are unwilling to divulge the process that is utilized to negotiate terms with creditors. Another problem with conventional debt settlement programs is that they provide no communication with the consumer as to the status of each creditor.

While these methods may be suitable for the particular purpose to which they address, they are not as suitable for the specific purpose of providing individuals with an internet based debt settlement module (program) that reduces overall debt while increasing cash flow at minimal cost to the consumer. The main problem with conventional debt settlement programs are the financial and budgetary limitations of the consumer as well as the traditional costs associated with the negotiation of any debt including but not limited to loans and lines of credit, medical bills, credit cards and the like. Secured lines of credit are not included in this process in that these loans are collateralized. Another problem is the overall lack of flexibility current debt settlement programs provide and the inability for the consumer to determine the order in which each creditor is negotiated with and the specific treatment each of their accounts will receive once placed with a traditional debt settlement company or attorney.

Therefore, a need existed to provide a system and method to overcome the above problem. The system and method will provide individuals with an internet based debt settlement module (program) that reduces overall debt at minimal cost to the consumer.

### SUMMARY OF THE INVENTION

A computer system comprising a processor for executing program instructions and a memory coupled to the processor for storing the program instructions, the programming instructions comprising: entering personal information of a user; entering debt information for each creditor of the user; generating a first letter to each creditor of inability of user to maintain current credit terms; and sending the first letter to each creditor.

A method of modifying a debt of a user comprising: entering personal information of a user into a database; entering debt information for each creditor of the user into a database; generating a first letter to each creditor of inability of user to maintain current credit terms by transferring the personal information and the debt information to a first letter template; and sending the first letter to each creditor.

The present invention is best understood by reference to the following detailed description when read in conjunction with the accompanying drawings.

### BRIEF DESCRIPTION OF THE DRAWINGS

FIG. 1 is a simplified block diagram of a system for debt settlement;

FIG. 2 is a perspective view of the present method that includes user input and output through the User database; and

FIG. 3 is a perspective view of the present method that includes creditor offers and output through the User database.

Common reference numerals are used throughout the drawings and detailed description to indicate like elements.

### DETAILED DESCRIPTION

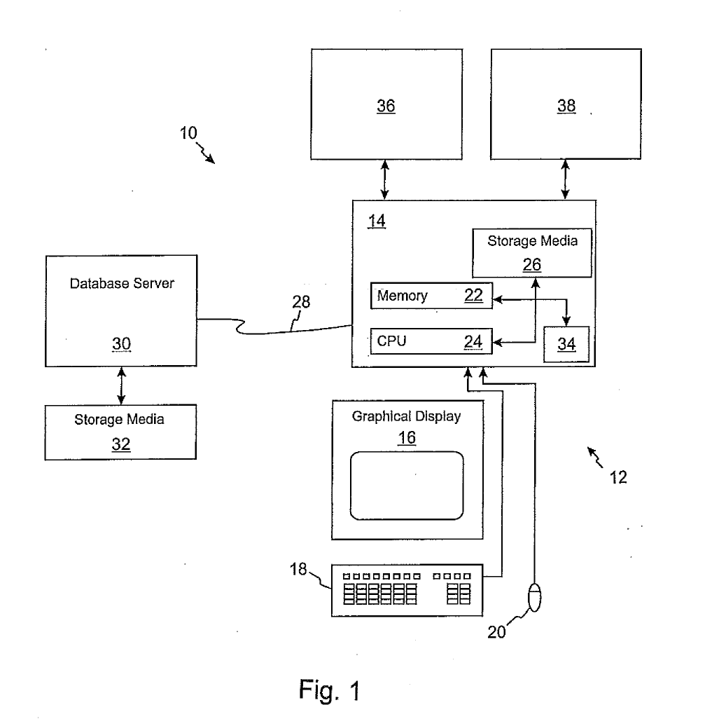

Referring to FIG. 1, a system 10 that allows an individual to negotiate directly with their creditors without the use of a debt settlement company and or attorney is shown. The system 10 generally uses a main computer system 12. The computer system 12 may have a processor unit 14 and a display 16. Input devices may be coupled to the processor unit 14. The input devices may be a keyboard 18, a mouse 20 and the like. The processor unit 14 may further have an I/O port 34 for downloading data to the processor unit 14. The I/O port 34 may be a USB port, a FireWire port or the like. The listing of the above is given as an example and should not be seen as to limit the scope of the present invention. Alternatively, the processor unit 14 may have a reading device 36 coupled to the processor unit 14. The reading device 36 may be a memory card reader or the like. The processor unit 14 may further have a scanning device 38 coupled thereto. The scanning device 38 could also be used to download data to the processor unit.

Through the execution of program instructions forming a computer program product within the computer system 12, the computer system 12 will provide a means to negotiate a debt of the individual directly with the creditors without the use of a debt settlement company and or attorney. The program instructions may be located within a memory 22 of the processor unit 14 and executed by a central processing unit 24 (CPU). Any data generated from the running of the program instructions such as a center of gravity of an aircraft and the like may be stored entirely within a storage media 26 and/or the memory 22.

Alternatively, the computer system 12 may have a connection 28 to a network such as a local-area network (LAN), wide-area network (WAN) or the Internet. The connection 28 may be a wired connection, a wireless connection, or the like. In a network implementation, the program instructions may be located within a database server 30.

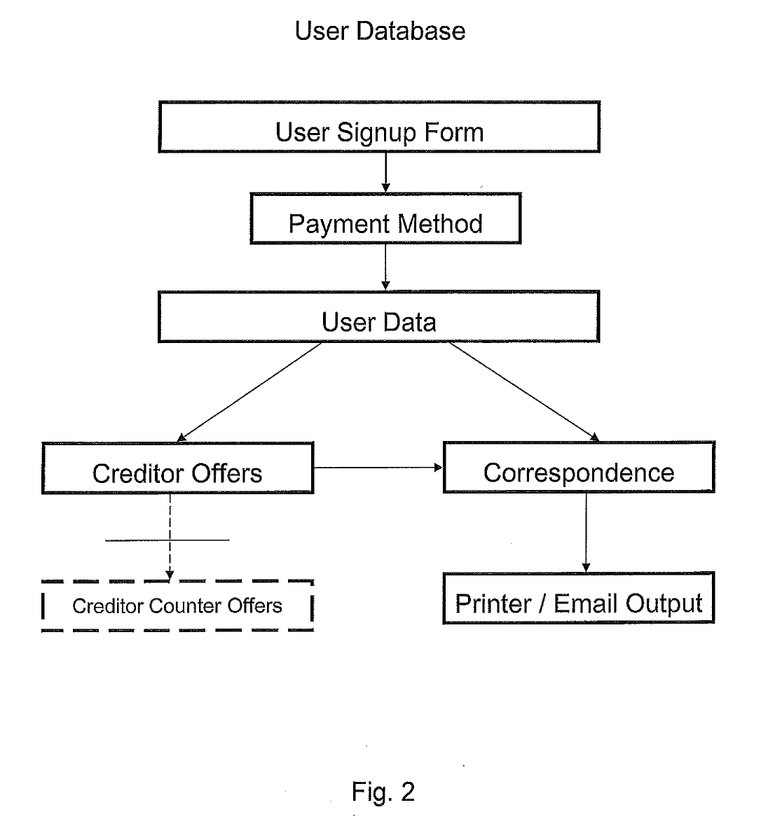

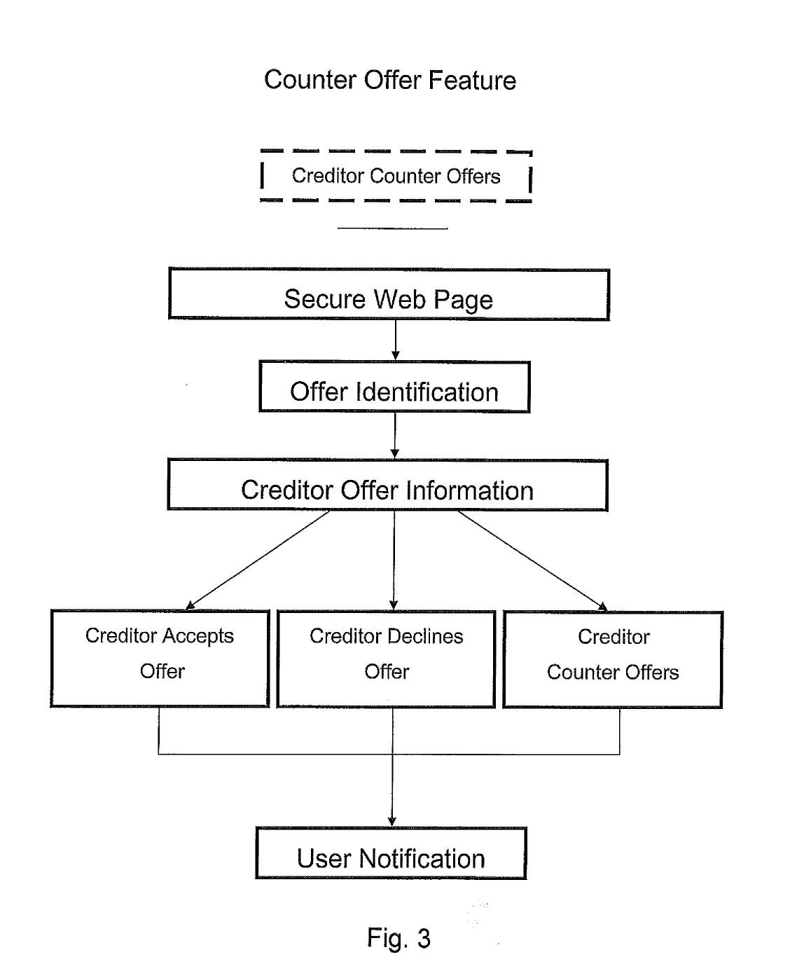

Referring now to FIGS. 1-3, a method of debt settlement will be described. When using the computer system 12, the user may access a screen display. The screen display may be part of the program instructions forming a computer program product within the computer system 12 or a website accessed via the connection 28 to a network. The method may use a database. The database may use various tables that store information, consumer signup forms, creditor data entry forms, offer and counter offer forms, a script that convert all fields in each form to “proper case”, letter generation scripts, letter re-generation scripts, email generation scripts, and the like. The database further may contain several tables that maintain all of the user input information including user, creditor, correspondence, and offer information. A correspondence module may be provided that contains proprietary letters and emails designed to generate the desired response based upon the type of treatment chosen by the user on each account.

The database contains several tables; these tables include but are not limited to the following: users, creditors, offers, counter offers and correspondence. The database also has connections to any merchant account to process payments. The database utilized can be in any format i.e. SQL Server, Access, MySql, FrontBase, OpenBase, Sybase, and the like. This database was designed to be used on the internet but could also be used on an intranet.

The database connection and scripts convert all data input to proper case (initial cap or other) structure for correspondence generation. The script that converts data input from any form to proper (initial cap) case. This could also be modified to contain any other connection (database, merchant account and Internet site), scripts (other plug-in) or Internet connection.

The forms used in entering the data into the database these include; User Signup, Creditors, Creditor Offers and Creditor Counter Offers. The forms are all connected to the database through various tables; the forms are the User Signup, Creditors, Creditor Offers and Creditor Counter Offers. The user signup gathers personal information i.e. name of user, address, phone number, email address and password. Once a consumer has filled out this form and submitted their information a client number is automatically generated and the account created. The creditor form allows a consumer that has signed up to enter each creditor(s). The information required is the name of the entity, address, phone number, amount owed and the like. From this point the consumer generates a letter via the database advising the creditor of their inability to maintain the current terms with the creditor. The consumer then waits a reasonable amount of time for a response to their initial letter. After this period of time if no reasonable solution is provided, the user will also be asked to select the desired program from a list of strategies. Once they entered this data into the database and the consumer selects the type of negotiation they are attempting in the offers table. Once this is done they are again able to generate a letter to the creditor with their offer. This letter provides an access code and a website hyperlink that directs the creditor to response page. This process can be accessed via telephone utilizing VOIP or other text to speech methods utilizing the same database. From this page the creditor is allowed to accept the offer, decline the offer or make a counter offer. Once the creditor has made their response, the consumer is notified that they have an answer. The answer may be via email, text message, voice message, mail, etc. The consumer then enters the website and is able to read the response from the creditor. If the offer is declined or countered, the consumer can make a new offer to the creditor again and the above process continues.

The correspondence module contains proprietary sample letters and emails designed to generate the desired response based upon the type of program chosen by the user on each account.

The key component is the database, this database can be in any format i.e. SQL Server, Access, MySql, FrontBase, OpenBase, Sybase, or any other database. This database stores the user information, creditor information, offer information and creditor counter offer information. Another key component is proper case script; this script converts all text data entered into the database to initial cap from all data entry forms thus insuring continuity of the data stored. This also ensures that any correspondence sent either to the creditor is formatted in a manner that always appears professional. While entering the data into any form this script “works on the fly” converting data to initial cap format and then written and/or inserted into the database for later. The database is accessed by html forms that connect to the database for either input or output. The forms allow the consumer and creditors to add data. All of the components of this method of internet debt settlement can be utilized via internet or intranet. The core components; the database and method utilized are the key to maintaining the structure of the data. Any of the correspondence could be altered to meet any consumer's individual needs.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A computer system comprising a processor for executing program instructions and a memory coupled to the processor for storing the program instructions, the programming instructions comprising:
entering personal information of a user;
entering debt information for each creditor of the user;
generating at least one first letter to each creditor of inability of user to maintain current credit terms; and
sending the first letter to each creditor.

2. The programming instructions in accordance with claim 1, further comprising:
selecting a desired payment plan for each creditor from a list of payment plans; and
sending at least one second letter to each creditor with the desired payment plan.

3. The programming instructions in accordance with claim 2, further comprising one of accepting or rejecting the desired payment plan by each creditor.

4. The programming instructions in accordance with claim 2, further comprising:
one of accepting or rejecting the desired payment plan by the creditor; and
sending a creditor letter to the user, the creditor letter accepting or rejecting the desired payment plan.

5. The programming instructions in accordance with claim 4, further comprising:
modifying the desired payment plan selected by the user by the creditor when the creditor rejects the desired payment plan; and
sending the modified desired payment plan in the creditor letter.

6. The programming instructions in accordance with claim 5, further comprising one of accepting or rejecting the modified desired payment plan by the user.

7. A method of modifying a debt of a user comprising:
entering personal information of a user into a database;
entering debt information for each creditor of the user into a database;
generating a first letter to each creditor of inability of user to maintain current credit terms by transferring the personal information and the debt information to a first letter template; and
sending the first letter to each creditor.

8. The method of claim 7, further comprising:
selecting a desired payment plan for each creditor from a list of payment plans stored in the database; and
sending a second letter to each creditor with the desired payment plan selected by the user by transferring the personal information and the desired payment plan to a second letter template.

9. The method of claim 8, further comprising one of accepting or rejecting the desired payment plan by each creditor.

10. The method of claim 8, further comprising:
one of accepting or rejecting the desired payment plan by the creditor; and
sending a creditor letter to the user, the creditor letter accepting or rejecting the desired payment plan.

11. The method of claim 8, further comprising:
rejecting the desired payment plan by the creditor;
modifying the desired payment plan selected by the user by the creditor when the creditor rejects the desired payment plan; and
sending the modified desired payment plan in the creditor letter.

12. The method of claim 11, further comprising one of accepting or rejecting the modified desired payment plan by the user.

13. A computer system comprising a processor for executing program instructions and a memory coupled to the processor for storing the program instructions, the programming instructions comprising:
entering personal information of a user into a database;
entering debt information for each creditor of the user into a database;
generating a first letter to each creditor of inability of user to maintain current credit terms by transferring the personal information and the debt information to a first letter template; and
sending the first letter to each creditor.

14. The programming instructions of claim 13, further comprising:
selecting a desired payment plan for each creditor from a list of payment plans stored in the database; and
sending a second letter to each creditor with the desired payment plan selected by the user by transferring the personal information and the desired payment plan to a second letter template stored in the database.

15. The programming instructions of claim 14, further comprising sending a response of one of accepting or rejecting the desired payment plan by each creditor.

16. The programming instructions of claim 14, further comprising:
one of accepting or rejecting the desired payment plan by the creditor; and
sending a creditor letter to the user, the creditor letter accepting or rejecting the desired payment plan.

17. The programming instructions of claim 14, further comprising:
rejecting the desired payment plan by the creditor;
modifying the desired payment plan selected by the user by the creditor when the creditor rejects the desired payment plan; and
sending the modified desired payment plan in the creditor letter.

18. The method of claim 17, further comprising one of accepting or rejecting the modified desired payment plan by the user.
